(19) United States
(12) Patent Application Publication
(10) Pub. No.: US 2010/0116732 A1
(43) Pub. Date: May 13, 2010

(54) IN-LINE STRAINER

(76) Inventor: Chang-moo JUNG, Seoul (KR)

Correspondence Address: BRINKS HOFER GILSON & LIONE, P.O. BOX 10395, CHICAGO, IL, 60610, US

(21) Appl. No.: 12/267,256

(22) Filed: Nov. 7, 2008

(51) Int. Cl. B01D 35/02

(52) U.S. Cl. 210/447

(57) ABSTRACT

The present invention relates to an in-line strainer including: a body formed of a linear pipe having an enlarged part formed increased in diameter in the middle portion thereof, and a fastening flange mounted at the both ends thereof in such a manner as to be connected coaxially to a pipeline by means of a gasket; and a mesh screen having a generally conical shape at the front end portion thereof and a generally cylindrical shape at the back end portion thereof in such a manner as to be coupled to the body, the mesh screen being inserted from the outlet port of the body and being disposed concentrically into the enlarged part of the body in such a manner as to place the front end portion thereof into the enlarged part of the body, having a predetermined space from the inlet port of the body.

### BACKGROUND OF THE INVENTION

1. Field of the Invention

The present invention relates to a strainer that is disposed in a variety of pipelines for conveying fluids therealong so as to filter foreign matters contained in the fluids, and more particularly, to an in-line strainer that has a flow passageway formed in the same direction as a pipeline in which the strainer is disposed, thereby substantially reducing the generation of vortexes, the frictional resistance, and the loss of pressure caused by the curving of the flow passageway.

2. Background of the Related Art

Generally, a pipeline formed of pipes is employed to convey a variety of fluids like oil, water, gas and steam, and further, a valve is mounted at a predetermined position on the pipeline, so as to conduct or stop the supply of the fluid, and alternatively, so as to appropriately adjust the flow rate of the fluid.

By the way, foreign matters like dust, scales, and so on may enter the interior of the pipeline from the outside to cause the formation of impurities in the fluid flowing along the pipeline, and in this case, the valve and the fluid pump conveying the fluid are damaged to reduce their life span. Moreover, the valve and the pipe are closed, such that they do not work anymore.

Therefore, a strainer is generally disposed in the vicinity of the valves on the pipeline so as to filter the foreign matters conveyed together with the fluid along the pipeline and so as to maintain the pipeline in a clean state by the periodical removal of the filtered foreign matters.

The strainer is classified into Y-type (marine type) and T-type (bucket type) strainers according to the shape, which are appropriately selected, depending upon the kinds of fluid flowing in the pipeline and the features of the pipeline equipment. Generally, the Y-type strainer is widely used.

FIG. 1 schematically shows a conventional Y-type strainer. As shown, the Y-type strainer includes: a body 1 connected to a pipeline and having an inlet part 1a to which a fluid is introduced, an outlet part 1b from which the fluid is discharged, the inlet part 1a and the outlet part 1b having the same center as each other, and a filter part 1c disposed between the inlet part 1a and the outlet part 1b in such a manner as to be branched inclined downwardly toward the outlet part 1b; a cylindrical mesh screen 2 housed in the filter part 1c of the body 1 so as to filter foreign matters contained in the fluid; and a cover 3 adapted to open and close the opening formed at the front end of the filter part 1c.

By the way, according to the conventional Y-type strainer, the filter part 1c is branched inclined downwardly to a predetermined angle from the body 1, such that the flow passageway is curved to undesirably permit the vortexes in the flow of fluid to be generated and further permit the fluid flowing in the pipe to have a high flow passageway resistance, which causes large loss of pressure in the pipeline.

Since the flow passageway is curved, additionally, the body 1 is worn out by the friction against the fluid, and the stress in the pipeline is increased, which makes the durability of the body decreased. Further, the body 1 is a relatively large and heavy casting product, thereby making it difficult to handle it.

On the other hand, even though not shown in the drawing, a T-type strainer is disclosed in Korean Utility Model Publication No. 1997-0002932, having the filter part housing the mesh screen formed perpendicular to the pipeline, such that the curving of the flow passageway is severely formed to cause the same problems as the Y-type strainer.

### SUMMARY OF THE INVENTION

Accordingly, the present invention has been made in view of the above-mentioned problems occurring in the prior art, and it is an object of the present invention to provide an in-line strainer that has a flow passageway formed in the same direction as a pipeline in which the strainer is disposed, thereby substantially reducing the generation of the vortexes, the frictional resistance, and the loss of pressure caused by the curving of the flow passageway.

It is another object of the present invention to provide an in-line strainer that reduces the friction and stress caused by the flow friction against the fluid flowing in a pipeline, thereby increasing the durability thereof, and that has a relatively small, simple and light body, thereby making it easy to handle it.

To accomplish the above objects, according to the present invention, there is provided an in-line strainer including: a body formed of a linear pipe having an enlarged part formed increased in diameter in the middle portion thereof, and a fastening flange mounted at the both ends thereof in such a manner as to be connected coaxially to the pipeline by means of a gasket; and a mesh screen having a generally conical shape at the front end portion thereof and a generally cylindrical shape at the back end portion thereof in such a manner as to be coupled to the body, the mesh screen being inserted from the outlet port of the body and being disposed concentrically into the enlarged part of the body in such a manner as to place the front end portion thereof into the enlarged part of the body, having a predetermined space from the inlet port of the body.

According to the present invention, preferably, the body has an inlet valve and a drain valve mounted respectively on the enlarged part thereof so as to feed and discharge a cleaning liquid to and from the interior of the enlarged part thereof, such that the foreign matters accumulated into the enlarged part are forcedly removed.

According to the present invention, preferably, the body is made by molding a metal pipe having the same material as the pipeline to a predetermined shape and is welded to the fastening flange at the both ends thereof.

According to the present invention, therefore, the flow passageway of the in-line strainer is formed in the same direction as the pipeline, such that the flow passageway resistance of the fluid flowing along the pipeline and the generation of vortexes in the fluid are all reduced, thereby ensuring the gentle and stable fluid flow and the reduction of the loss of pressure.

According to the present invention, furthermore, the friction and stress of the strainer caused by the flow friction against the fluid flowing along the pipeline are reduced, thereby increasing the durability of the strainer, and the strainer has a light, small and simple body by means of molding, thereby making it easy to handle it.

Accordingly, the strainer of this invention provides high efficiencies in reliability, durability, and easiness of handling.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a sectional view showing a conventional Y-type strainer;

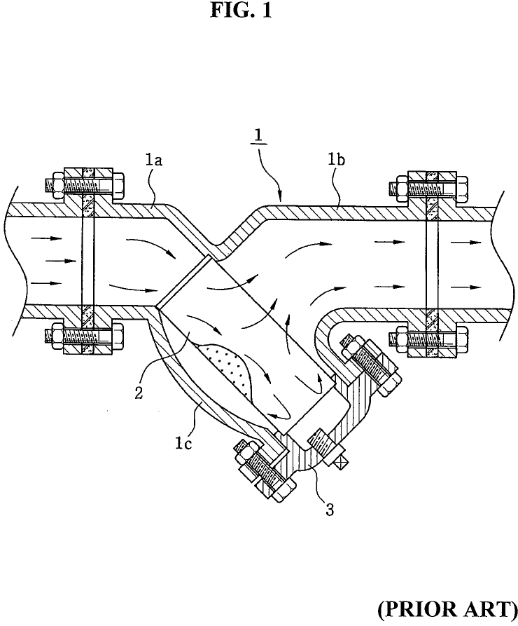

FIG. 2 is an exploded perspective view showing an in-line strainer according to a first embodiment of the present invention;

FIG. 3 is a sectional view showing the assembled state of the in-line strainer in FIG. 2;

FIG. 4 is a sectional view showing the operation of the in-line strainer according to the first embodiment of the present invention;

FIGS. 5a to 5c are sectional views showing the processes for cleaning the in-line strainer according to the first embodiment of the present invention; and

FIG. 6 is a sectional view showing an in-line strainer according to a second embodiment of the present invention.

### DETAILED DESCRIPTION OF THE PREFERRED EMBODIMENT

Hereinafter, an explanation on an in-line strainer according to the preferred embodiments of the present invention will be given with reference to the attached drawings.

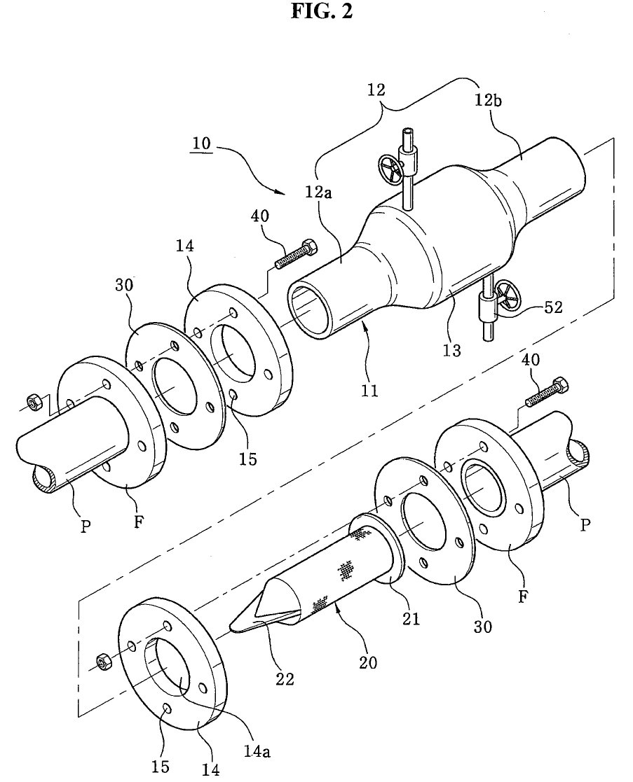

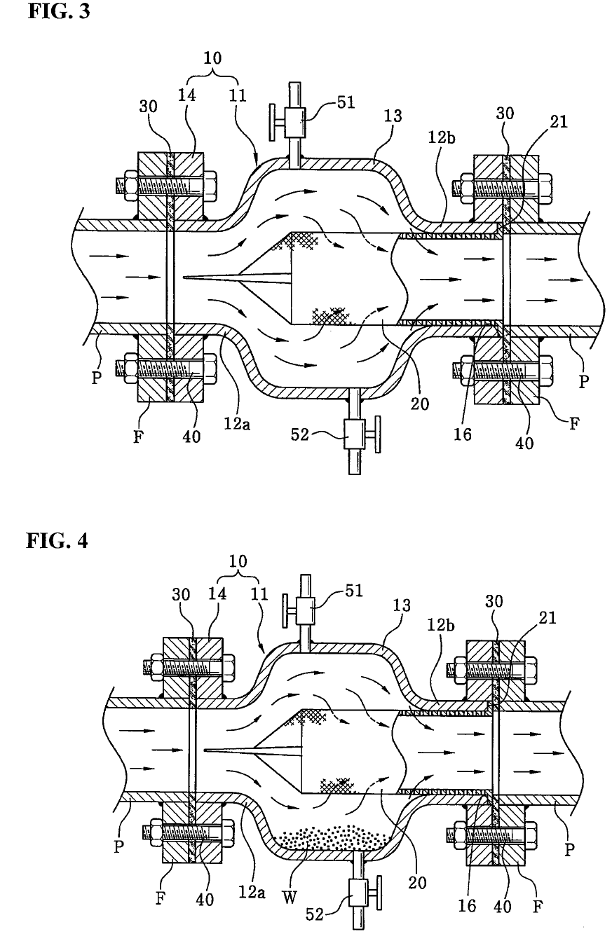

As shown in FIGS. 2 and 3, an in-line strainer according to a first embodiment of the present invention includes: a body 10 formed of a linear pipe having an enlarged part 13 formed increased in diameter in the middle portion thereof and connected coaxially to a pipeline P; and a mesh screen 20 adapted to be inserted into the enlarged part 13 of the body 10 and disposed concentrically in the pipeline P, having a predetermined space from the body 10, so as to filter foreign matters W contained in the fluid flowing along the pipeline P.

The body 10 has a fastening flange 14 mounted at the both ends thereof in such a manner as to be connected coaxially to the pipeline P by fastening a flange F of the pipeline P and a gasket 30 to the fastening flange 14 by means of bolts 40, the fastening flange 14 having a plurality of fastening holes 15 formed at predetermined intervals thereon.

The body 10 may be formed of a single body by means of molding, but preferably, the body 10 is formed of a metal pipe by means of molding, which includes a main body 11 having the enlarged part 13 increased in diameter in the middle portion thereof and extended to a predetermined length, and the round fastening flange 14 mounted at the both side end portions of the main body 11 in such a manner as to be integrally coupled along the outer peripheries of small radius parts 12 forming an inlet port 12a and an outlet port 12b for a fluid by means of welding.

Thus, the main body 11 has a generally barrel-like sectional shape and also has the same material and thickness as the pipeline P so as to be sufficiently resistant to the pressure in the pipeline P.

At this time, the front end periphery of the outlet port 12b of the body 10 is not fully inserted into an assembling aperture 14a of the fastening flange 14 to be welded thereto, but it is inserted partially into the assembling aperture 14a and is welded to the fastening flange 14 in such a manner as to be spaced apart from the outer face (which abuts against the flange F of the pipeline P) of the fastening flange 14 by a predetermined distance, thereby forming a seating portion 16.

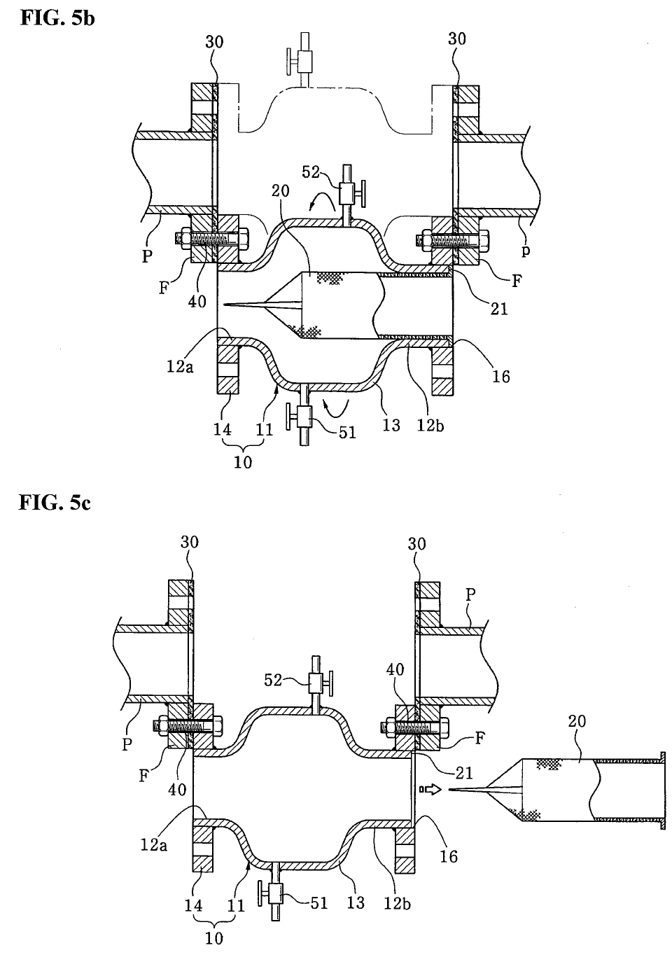

In this case, the seating portion 16 is formed to the length of the outlet port 12b of the main body 11 with respect to the assembling aperture 14a of the fastening flange 14, such that the mesh screen 20 is easily separated from the body 10 even when the strainer is rotated and escapes from the pipeline P after some of the bolts 40 are unfastened, without any complete separation of the strainer from the pipeline P upon the cleaning of the pipeline P, as shown in FIG. 5b.

The mesh screen 20 has a generally conical shape at the front end portion thereof and a generally cylindrical shape at the back end portion thereof. The back end periphery of the mesh screen 20 has a locking flange 21 adapted to be coupled to the seating portion 16 formed along the front end of the outlet port 12b of the body 10, so as to fixedly mount the mesh screen 20 at the body 10.

The mesh screen 20 is inserted from the outlet port side 12b of the body 10 and is disposed concentrically in the enlarged part 13 of the body 10 in such a manner as to place the front end portion thereof into the enlarged part 13 of the body 10, having a predetermined space from the inlet port 12a of the body 10. Therefore, flow passageways are formed between the front end portion of the mesh screen 20 and the enlarged part 13, and so as to gently flow the fluid into the enlarged part 13, the front end portion of the mesh screen 20 desirably has a generally conical shape.

Further, the mesh screen 20 includes a relatively thin plate-like guide 22 extended horizontally from the conical front end thereof to the inlet port 12a by a predetermined length, so as to induce the fluid in upward and downward directions of the enlarged part 13 of the body 10.

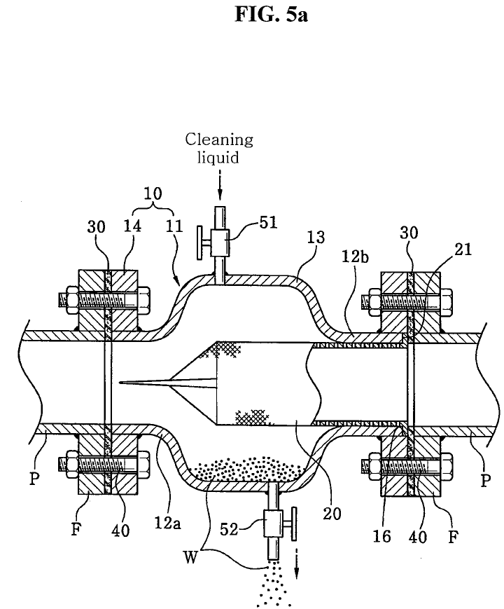

On the other hand, unlike the conventional strainers, the in-line strainer of this invention is configured wherein the foreign matters W contained in the fluid are not filtered at the inside of the mesh screen 20, but they are filtered at the outside of the mesh screen 20, as shown in FIG. 4, such that they are accumulated into the enlarged part 13 of the body 10. Desirably, the body 10 has an inlet valve 51 and a drain valve 52 mounted respectively on the enlarged part 13 thereof so as to feed and discharge a cleaning liquid to and from the interior of the enlarged part thereof, such that the foreign matters W accumulated into the enlarged part are discharged and the mesh screen 20 is cleaned, without any separation of the strainer from the pipeline P.

Next, an explanation on the operation and cleaning method of the in-line strainer according to the present invention will be given.

As shown in FIG. 4, the in-line strainer according to the present invention is disposed in a line with the pipeline P, and the fluid introduced to the inlet port 12a of the body 10 from the pipeline P flows to the space between the enlarged part 13 in the middle of the body 10 and the mesh screen 20. Next, the fluid is moved to the outlet port 12b via the front end portion of the mesh screen 20 placed at the center of the enlarged part 13.

Unlike the conventional Y-type and T-type strainers, the in-line strainer according to the present invention can convey the fluid in the same direction as the pipeline P in gentle and smooth manners, without any drastic change in the flowing direction thereof in the interior of the strainer, thereby filtering the foreign matters W contained in the fluid by means of the mesh screen 20.

Therefore, vortexes are not almost generated in the interior of the strainer, and the loss of pressure is substantially decreased, such that the fluid can flow at a substantially uniform pressure.

Also, the fluid gently flows without any drastic change in the flowing direction thereof, such that the abrasion of the strainer caused by the flowing friction of fluid against the strainer can be minimized, and further, the strainer body has a simple linear structure to remarkably reduce the portion where stress is generated, thereby greatly increasing the durability of the strainer.

Especially, the foreign matters W filtered by means of the mesh screen 20 are accumulated on the bottom of the enlarged part 13 of the body 10, without any collection in the inside of the mesh screen 20, as shown in FIG. 4, such that even though the foreign matters W are accumulated by a predetermined quantity, they do not give any interference in the flow of the fluid, and further, the accumulated foreign matters W do not cause pressure drop in the flow of the fluid.

On the other hand, the foreign matters W accumulated into the enlarged part 13 of the body 10 can be simply removed by means of the inlet valve 51 and the drain valve 52, without any separation of the strainer from the pipeline P.

In other words, the activation of the pipeline P system stops every a predetermined period of time, and the valve is closed to block the strainer. After that, as shown in FIG. 5a, the inlet valve 51 and the drain valve 52 are opened to introduce a cleaning liquid like a cleaning agent through the inlet valve 51 and to discharge the cleaning liquid through the drain valve 52, thereby simply cleaning the strainer.

Also, when the entire pipeline P is periodically checked every a predetermined period of time, as shown in FIG. 5b, some of the bolts 40 fastening the strainer to the flange F of the pipeline P are unfastened to rotate the strainer with respect to the shafts of lower bolts 40 and permit the strainer to partially escape from the pipeline P. Next, as shown in FIG. 5c, the mesh screen 20 is separated from the body 10, so that the body 10 can be sufficiently cleaned, without any complete separation from the pipeline P.

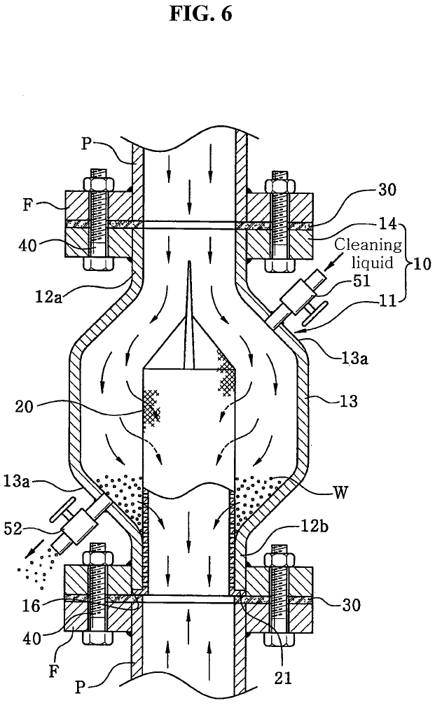

FIG. 6 is a sectional view showing an in-line strainer according to a second embodiment of the present invention. According to the second embodiment of the present invention, the inlet valve 51 and the drain valve 52 are disposed up and down in symmetrical relation with each other at the shoulder parts 13a of the enlarged part 13 of the body 10.

According to the second embodiment of the present invention, if the strainer is mounted on the pipeline P vertically formed, the foreign matters W accumulated on the bottom of the enlarged part 13 of the body 10 are easily removed, without any separation of the strainer from the pipeline P.

As mentioned above, the in-line strainer according to the present invention has the flow passageway formed in the same direction as the pipeline in which the strainer is disposed, thereby substantially reducing the flow passageway resistance of the fluid flowing along the pipeline and the generation of the vortexes in the pipeline, which ensures the gently and stable conveyance of the fluid and the reduction of the loss of pressure.

In addition, the in-line strainer of this invention reduces the friction and stress caused by the flow friction against the fluid flowing along the pipeline, thereby increasing the durability thereof, and has a relatively small, simple and light body, thereby making it easy to handle it.

Hence, the in-line strainer of this invention provides high efficiencies in reliability, durability, and easiness of handling.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An in-line strainer disposed at a variety of pipelines so as to filter foreign matters contained in a fluid flowing along the pipelines, the in-line strainer comprising:
a body formed of a linear pipe having an enlarged part formed increased in diameter in the middle portion thereof, and a fastening flange mounted at the both ends thereof in such a manner as to be connected coaxially to the pipeline by means of a gasket; and
a mesh screen having a generally conical shape at the front end portion thereof and a generally cylindrical shape at the back end portion thereof in such a manner as to be coupled to the body, the mesh screen being inserted from the outlet port of the body and being disposed concentrically into the enlarged part of the body in such a manner as to place the front end portion thereof into the enlarged part of the body, having a predetermined space from the inlet port of the body.

2. The in-line strainer according to claim 1, wherein the body has an inlet valve and a drain valve mounted respectively on the enlarged part thereof so as to feed and discharge a cleaning liquid to and from the interior of the enlarged part thereof.

3. The in-line strainer according to claim 2, wherein the inlet valve and the drain valve are disposed at shoulder parts formed to face each other on the enlarged part of the body.

4. The in-line strainer according to any one of claims 1, wherein the mesh screen further comprises a guide extended horizontally from the front end thereof so as to induce the fluid in upward and downward directions of the enlarged part of the body when the fluid flows into the enlarged part.

5. The in-line strainer according to claim 1, wherein the body is made by molding a metal pipe having the same material as the pipeline to a predetermined shape and is welded to the fastening flanges at the both ends thereof.

6. The in-line strainer according to claim 1, wherein the body has a seating portion formed around an opening of the outlet port thereof, and the mesh screen has a locking flange adapted to be coupled to the seating portion.
